(19) United States
(12) Patent Application Publication
(10) Pub. No.: US 2008/0211266 A1
(43) Pub. Date: Sep. 4, 2008

(54) Blind Device Comprising A Damping Mechanism

(75) Inventors: Alexander Bergmiller, Koenigsbrunn (DE); Peter Oberhaus, Paehl (DE); Michael Koelbl, Neuried (DE); Thomas Rudolph, Hechendorf (DE); Horst-Martin Schulz, Weil (DE); Christian Adlhoch, Muenchen (DE); Sebastian Glasl, Muenchen (DE)

Correspondence Address: ROBERTS MLOTKOWSKI SAFRAN & COLE, P.C., P. O. BOX 10064, MCLEAN, VA, 22102-8064, US

(73) Assignee: WEBASTO AG, Stockdorf (DE)

(21) Appl. No.: 11/813,732

(22) PCT Filed: Jan. 10, 2006
(86) PCT No.: PCT/DE06/00021

§ 371 Date: Jul. 11, 2007

(30) Foreign Application Priority Data
Jan. 11, 2005 (DE) 20 2005 000 363.8

(51) Int. Cl. E06B 9/56; B62D 25/06

(52) U.S. Cl. 296/211; 160/296

(57) ABSTRACT

Uncontrolled take-up of a shade and often unexpected noise development are perceived as disturbing by the operator. Therefore, it is provided that a shade arrangement with a length of shade material (10) and a take-up roll (12) to which the length of shade material is attached and which is pretensioned by spring force in the take-up direction of the length of shade, has a pressure volume (46) coupled to the free end (16) of the length of shade material (10) such that, when the length of shade material is unrolled from the take-up shaft (12), a pressure is built up in the pressure volume which, when the length of shade material is released from a position in which it is at least partially unrolled from the take-up roll, the take-up motion of the length of shade is braked.

### BACKGROUND OF THE INVENTION

1. Field of the Invention

The invention relates to a shade means with a length of shade material and a take-up roll to which the length of shade material is attached and which is pretensioned by spring force in the take-up direction of the length of shade. Furthermore, this invention also relates to a motor vehicle roof with such a shade arrangement.

2. Description of Related Art

Shade means of the initially named type are used for numerous applications, especially for shading purposes, for example, on buildings or in automotive construction, especially as cargo space covers and trunk covers, and also as covers, for example, for cabinets or chests.

To activate such a shade arrangement, the length of shade material is unrolled from the take-up roll against the force of a return spring and is fixed in at least the partially unrolled state, for example, hung. In order to then uncover the shaded area, the free end of the length of shade material is unfixed so that the length of shade material automatically is taken up under the action of spring force.

Even if provision is made for the length of shade material to be guided as it moves, for example, by a pull being attached to the free end of the length of shade material and being guided in lateral guide rails, uncontrolled take-up of the shade in which the shade snaps back under the action of a spring force has proven disadvantageous, on the one hand, since high take-up speeds can cause damage to part of the shade means, and on the other hand, uncontrolled take-up of the shade due to the associated jerky motion of the shade and the unwanted and often unexpected noise development when the pull strikes a stop are perceived as disturbing by the operator.

German Utility Model DE-U-92 03 450 proposes, especially for a freezer chest means, a shade means in which the take-up shaft is connected to a rod with one end projecting into a space which is filled with a highly viscous fluid. Because, when the rod turns within the highly viscous fluid, shear of the fluid occurs along the surface of the rod located in the fluid, the rotation of the rod at higher speeds of the take-up shaft is braked. Aside from the fact that, in this approach, only rather limited damping can be produced, in the implementation of such a shade system in which a moving component is guided out of a liquid filled chamber, inherent sealing problems arise.

Furthermore, German Patent DE 44 22 842 C1 proposed damping elements to brake the motion of the movable part. Similarly to DE-U 92 03 450, in this connection, a hollow chamber is filled with a viscous material, especially oil, in order to dampen the motion of the component turning in the hollow chamber.

To brake spring shades, damped stops have also been used which a pull connected to the free end of the length of shade material strikes when the shade is completely opened, i.e., is taken up as far as possible onto the take-up shaft. By using these buffers, the problems associated with snap-back of the shade can be mitigated only to a limited extent, but in no case can they be eliminated. Since the buffer is used only in the very last part of the opening motion of the shade, with buffers, the unduly rapid recoil motion of the shade which often leads to startling of the operator cannot be influenced, and moreover, the impact of the pull or the sliders guiding the pull leads to unwanted noise development and to wear phenomena on the shade means.

### SUMMARY OF THE INVENTION

Therefore, it is the object of this invention to devise a shade means of the initially named type in which, when the length of shade material is released from a position which is at least partially unrolled from the take-up roll, the take-up motion of the length of shade material is effectively damped.

This object is achieved in a shade means of the initially named type in that a pressure volume is coupled to the free end of the length of shade material such that when the length of shade material is unrolled from the take-up roll, a pressure is built up in the pressure volume which brakes the take-up motion of the length of shade material when the length of shade material is released from the position which is at least partially unrolled from the take-up roll.

This approach is advantageous in several respects. On the one hand, here, differently than with the stop buffers known from the prior art, the braking action of the shade which is being taken up as a result of the spring force of the take-up roll occurs not only at the end of the take-up motion, but beforehand, and in particular, provision can be made for the damping action to increase with rising take-up speed. In particular, snap-back of the shade, as can be observed in known shades, is thus effectively prevented. Furthermore, since the pressure in the pressure volume is built up only when the length of shade material is unrolled from the take-up roll, there is a system which is unpressurized at rest, and which works without wear and in a maintenance-free manner.

While the pressure volume can fundamentally be operated with any pressure fluid, i.e., liquid or gas, it is preferably operated with air in order to make the build-up as simple as possible.

To actuate the pressure volume, the latter is preferably coupled via a sheathed cable arrangement to the free end of the length of shade. The positioning motion of the shade in this connection via the sheathed cable arrangement in the pressure volume builds up a pressure and brakes the take-up motion when the length of shade material is moving in the opposite direction.

Preferably, there is a pull on the free end of the length of shade material which provides for uniform and wobble-free movement of the length of shade. In this connection, laterally from the length of shade, there can be guide rails in which the pull is directly guided or in which sliders connected to the pull are movably guided.

Preferably, the pressure volume is provided by a pressure cylinder which is coupled to the free end of the length of shade material and in which, preferably, there is a movable pressure piston which determines the size of the pressure volume. If, when the length of shade material is being taken up and unrolled its free end is moved, the pressure piston coupled to the free end or to a pull provided on it or to the sliders connected to the pull moves back and forth accordingly in the pressure cylinder.

While the coupling between the length of shade material and the pressure piston, in this connection, can take place fundamentally in any manner, the structure is especially simple when the pressure piston is coupled via a sheathed cable arrangement to the free end of the length of shade. Sheathed cables can be any elements, such as, for example, cables, cords, wire ropes, chains and the like, with tensile strength, preferably with tensile and compressive strength, which are still preferably flexible. Alternatively, the pressure piston located in the pressure cylinder could also be actuated by means of a connecting rod coupled to the free end of the length of shade.

The shade means can be made in this connection such that the pressure piston is shifted in the take-up motion of the length of shade material between a first end position in which the pressure volume is minimum, and a second end position in which the pressure volume is maximum. The arrangement can be made here such that the take-up motion of the length of shade material is damped either by means of a negative pressure produced in the pressure volume or by means of an overpressure produced in the pressure volume. If the damping is to take place by means of negative pressure, the shade means is preferably made such that the pressure piston is in the first end position, i.e., in the position in which the pressure volume is minimum when the length of shade material is unrolled to the maximum degree from the take-up roll, so that the pressure piston when the length of shade material is being taken up, when it is shifted in the direction to the second end position, produces a negative pressure by increasing the pressure volume. In this configuration of the shade means the pressure cylinder preferably has an air inlet opening and an air outlet opening provided with a one-way valve, the air inlet and outlet openings being arranged such that the pressure volume in movement of the pressure piston in the direction to the first end position being vented via the air outlet opening, during displacement of the pressure piston in the direction to the second end position in the pressure volume by increasing the pressure volume into which air cannot flow through the now closed one-way valve a negative pressure is produced, and air can flow into the pressure volume through the air inlet opening when the pressure piston reaches the second end position. In this configuration of the shade means the pressure cylinder provides for damping of the winding motion of the length of shade material as soon as the shade is released from the at least partially unrolled position, since by moving the pressure piston the closed pressure volume is enlarged. Only when the second end position is reached, in which the shade is completely taken up, can air flow into the pressure cylinder through the air inlet opening so that the pressure volume becomes unpressurized again. Moreover in this configuration of the shade means, the damping of the winding motion increases with the progressing motion of the shade. In particular, since the negative pressure produced in the pressure volume will be maximum shortly before reaching the second end position at the end of the take-up motion, at the end of the take-up motion maximum damping is achieved, while at the start of the take-up motion, proceeding from the unpressurized pressure volume which is “pumped empty” via the one-way valve, the length of shade material is not braked.

Similar damping behavior can be achieved when the shade means is made such that the pressure piston is in the second end position, i.e., in the end position in which the pressure volume is maximum, when the length of shade material is unrolled from the take-up roll to the maximum degree. As a result, an overpressure is produced when the length of shade material is taken up onto the take-up roll with the corresponding motion of the pressure piston in the direction toward the first end position in the pressure volume.

In this connection, the arrangement can be such that the pressure cylinder has an air passage opening which is arranged such that, when the pressure piston moves in the direction to the second end position, i.e., when the shade is unrolled, air can flow through the air passage opening into the pressure volume, and when the pressure piston is moved in the direction to the first end position, i.e., when the shade is being taken up, air from the pressure volume can escape through the passage opening. It goes without saying that, to produce an overpressure in the pressure volume, the air passage opening is dimensioned such that the amount of air flowing out through the air passage opening per unit of time is less than the amount of air displaced by the pressure piston (i.e., in order to produce a damping action, the area of the air passage opening must be smaller than the cross-sectional area of the pressure cylinder). In order to achieve a suitable damping action, in this connection, the air passage opening as compared to the cross-sectional area of the pressure cylinder will be small, and by the dimensioning of the air passage opening, the degree of damping can be set at will.

If the pressure piston is actuated via a sheathed cable arrangement, in another configuration of the invention, the shade means is made such that the pressure piston can be moved in both directions by the sheathed cable arrangement so that compressively stiff elements need not be provided as the sheathed cable elements, but only elements, such as, for example, cables, with tensile strength, can be used. In this case, the cable can be attached on either side of the pressure piston, for example, by means of hooks, or in a preferred configuration of the invention, can penetrate the pressure piston. In particular, the pressure piston can have an axial slot into which the cable is inserted.

Furthermore, the pressure piston can be attached to the cable by means of clamping, cementing, welding, crimping and/or by separate holding elements. In these embodiments, since the cable runs through the pressure volume, it goes without saying that, on the end of the pressure volume facing away from the pressure piston, there should be a corresponding sealing element in order to seal the moving cable relative to the pressure cylinder. The pressure piston itself can be sealed relative to the pressure cylinder in the conventional manner by means of seals which run circumferentially around the outside of the piston, for example, O-ring seals.

If a sheathed cable arrangement is used to move the pressure piston, it can have a revolving cable, especially an inherently closed revolving cable which is coupled, on the one hand, to the free end of the length of shade material and to which, on the other hand, a pressure piston is attached. To equalize production and mounting tolerances, there can be a compensation element, for example, a tension spring, in the revolving cable.

To dampen the take-up motion of the length of shade material, there can be one or more pressure cylinders. For example, there can be a pressure cylinder which is coupled on each side to the free end of the length of shade, especially to a pull which is provided on the free end of the length of shade material or to a slider which is connected to the pull. Alternatively, on either side of the length of shade material, there can be a respective separate pressure cylinder, with pressure pistons which are coupled to one end of the pull and to a slider which is connected to the pull.

While shade means of the above explained type can be used in numerous applications, especially for shading of window openings, to separate spaces, to close cabinets and chests and the like, an especially preferred application is in automotive construction where these shade means can be used as cargo space covers, for example, as trunk lids or for covering the cargo bed of pickups, but mainly for shading a sunroof which has a transparent or translucent cover.

With the concept described here, in which the opening process of a manually actuated, spring-tensioned shade, a so-called spring shade, is damped in a specific manner, on the one hand, the ease of operation of the shade means is increased since snap-back of the shade is prevented, the shade slides back gently and unwanted noise as occurs when the known shade strike a buffer are avoided, and on the other hand, the stress on the components is reduced as a result of the damped return of the length of shade. Compared to known shade means in which the length of shade material snaps back in an uncontrolled manner, an increased value of the system is achieved by the damped return motion of the length of shade.

Preferred embodiments of the invention are explained in detail below with reference to the accompanying drawings.

### BRIEF DESCRIPTION OF THE DRAWINGS

FIG. 1 is a schematic perspective view of a shade means in accordance with the invention;

FIGS. 2 to 5 show views of one embodiment of a pressure cylinder which works with negative pressure in different operating positions of the pressure piston;

FIGS. 6 to 9 show views of a pressure cylinder which works with overpressure in different operating positions of the pressure piston;

FIGS. 10 A & 10B show detailed end and side views of a sealing element for sealing the pressure cylinder;

FIGS. 11A, B & 12A, B show detailed side and end views of embodiments of the pressure piston;

FIG. 13 is a schematic perspective view of an alternative embodiment of the shade means in accordance with the invention in which there is only one pressure cylinder for damping of the take-up motion of the length of shade;

FIG. 14 is a schematic perspective view of another embodiment of a shade means which works with a pressure cylinder;

FIG. 15 is a schematic perspective view of a configuration of a shade means which operates with a pressure cylinder and in which there are two pressure cylinders in the pull;

FIG. 16 is a sectional view through a guide rail for use with a shade means in accordance with the invention; and

FIGS. 17 to 19 show another version of a pressure cylinder which is used in the shade means in accordance with the invention.

### DETAILED DESCRIPTION OF THE INVENTION

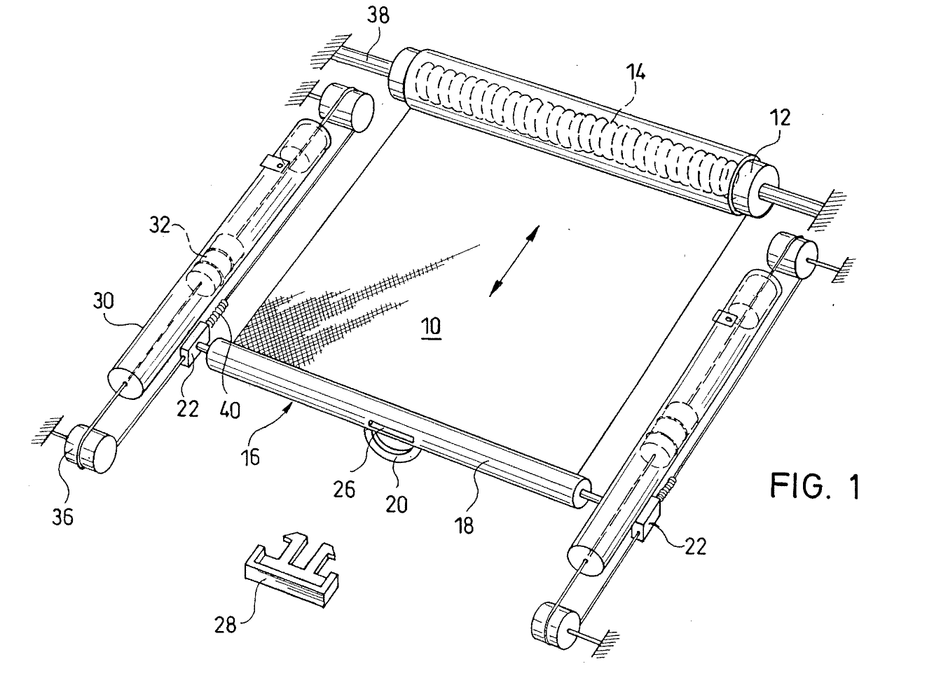

FIG. 1 shows a shade means in which the length of shade material 10 is taken up onto a take-up shaft 12 which is pretensioned by means of a spring 14 in the take-up direction of the length of shade material 10. The length of shade material 10 can be preferably lengths of fabric which, depending on the application, can also be provided with a light reflecting or heat reflecting layer.

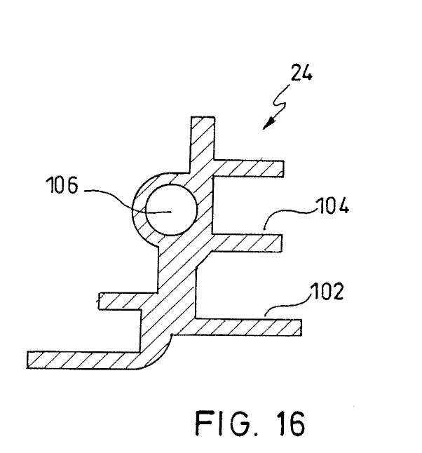

In the embodiment shown in FIG. 1, there is a pull 18 on the free end 16 of the length of shade material 10 that is provided with a handle 20 for actuation by the operator. Each end of the pull 18 is connected to a slider 22. Sliders 22 are guided in guide rails 24 (such as that shown in FIG. 16) and which are run parallel to the drawing direction of the shade.

To draw the length of shade material 10, the operator pulls the pull 18 on the handle 20 in a direction away from the take-up shaft 12, as a result of which the length of shade material 10 is unrolled from the take-up shaft 12 against the reset force of the springs 14. In order to keep the length of shade material in a position which is at least partially unrolled from the take-up shaft 12, the free end of the length of shade material is locked in the pertinent position. For this purpose, laterally of the length of shade material 10, there can be several catch hooks, or as shown in FIG. 1, there can be a locking mechanism 28 which interacts with an engagement part 26 which is provided in the pull 18 and which locks the pull in its end position which completely stretches the length of shade material 10.

If the length of shade material is to be taken up, the locking is released so that the pull 18 is drawn back under the action of the force of the spring 14. In order to damp this return motion of the pull 18 and especially to prevent the shade from snapping back, there is a pressure cylinder 30 on each side of the length of shade 10. While, in the illustrated embodiment, the pressure cylinder is an elongated component with a circular cross section, it goes without saying that the pressure cylinder can be any hollow profile with a uniform cross section which can have any cross sectional shape, for example, round, oval, angular, etc. In the pressure cylinder 30, there is a pressure piston 32 which is coupled via a revolving (endless) cable to the slider 22 which bears the pull 18.

In this embodiment, the cable 34 runs axially through the pressure cylinder 30 and is deflected via deflection rollers 36 to form a closed loop. Instead of concomitantly turning deflection rolls 36, deflection can also take place via a stationary component, for example, a metal pin. Furthermore, in the embodiment shown in FIG. 1, the deflection roll 36 located nearer the take-up roll can be located on the axle 38 of the take-up shaft 12 or deflection of the cable 34 can take place directly via the axle 38.

In order to equalize tolerances in the production and mounting of the shade means and especially of the sheathed cable system thereof, in the cable 34 which can be, for example, a plastic-jacketed wire rope, there can be an equalization element 40, for example, a tension spring.

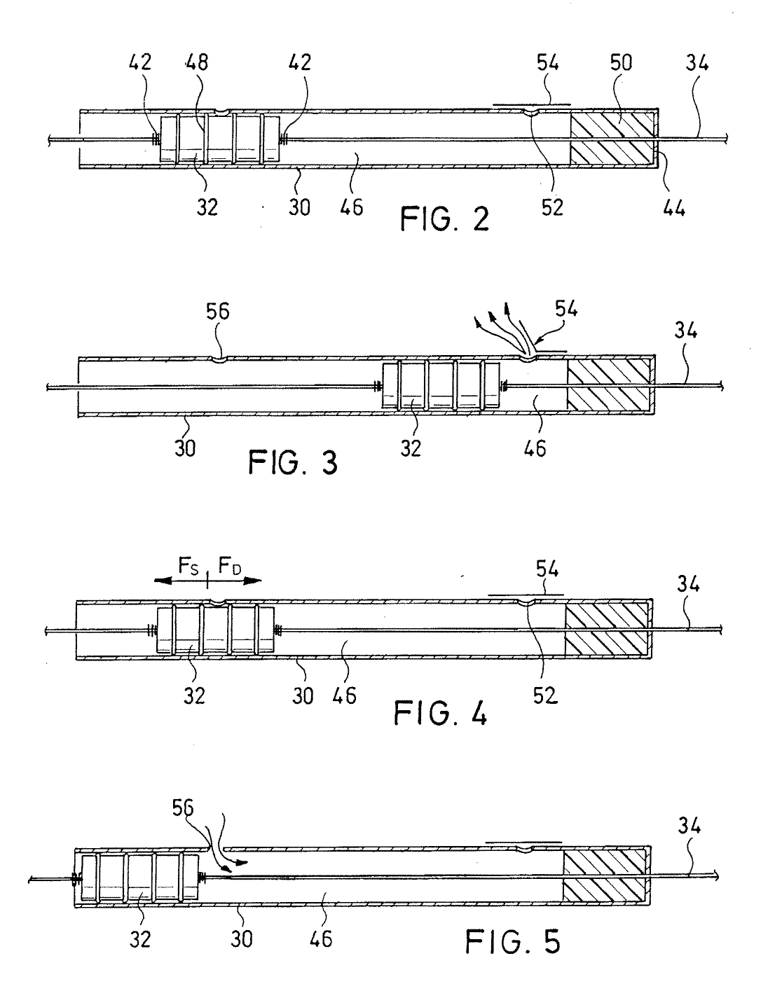

With reference to FIGS. 2 to 5, an embodiment of the pressure cylinder 30 is explained below in which the take-up motion of the length of shade material is damped by the build-up of a negative pressure. If the pull 18 is moved in the direction to the take-up shaft proceeding from the completely closed position of the shade (FIG. 5), the pressure piston 32, which is located in the pressure cylinder 30 and which is attached, for example, by means of crimp elements 42 on the cable 34, is moved to the right in FIG. 2. While the end of the pressure cylinder 30 shown at left in FIG. 2 can be open, the other end 44 of the pressure cylinder 30 is closed in order to form a variable pressure volume 46 between the cylinder and the pressure piston 32. In this connection, the pressure piston 32 is sealed relative to the inside wall of the pressure cylinder 30, preferably, by means of a plurality of O-rings 48. Furthermore, on the closed end 44 of the pressure cylinder 30, there is a sealing element 50 which provides for sealing between the movable cable 34 and the pressure cylinder 30. Adjacent to the closed end 44, or the sealing element 50 located therein, the pressure cylinder 30 has an air outlet opening 52 which is sealed by means of a one-way valve 54 such that air can escape from the interior of the pressure cylinder, but no air can travel through the air outlet opening into the pressure cylinder.

If the pressure piston 32 is moved from the position shown in FIG. 2 into the position shown in FIG. 3, air is compressed in the pressure volume, but can escape via the air outlet opening 52. As soon as the shade is closed to a length enough that the air dammed in the pressure volume 46 can escape sufficiently via the air outlet opening 52, the pressure between the pressure chamber 46 and the outside space surrounding the pressure cylinder 30 is equalized via the one-way valve 54.

If the free end of the length of shade material proceeding from the closed position of the length of shade material shown in FIG. 3 is released, the pressure piston 32 on the cable 34 within the pressure cylinder 30 is pulled to the left in FIG. 3. By increasing the pressure volume 46, a negative pressure is formed in the pressure volume 46 since the one-way valve 54 seals the air outlet opening 52, and thus, the pressure cannot be equalized. As a result of the negative pressure in the pressure volume 46 a compressive force F_{D} which is directed against the tensile force F_{S} of the cable 34 acts on the pressure piston 32 and becomes greater with increasing displacement of the pressure piston 32 in the direction to be opened, i.e., the completely taken-up position of the shade, and thus, causes an increasing damping action.

When the completely taken-up position of the length of shade material 10 is reached, in which the pressure piston 32 is in the end position shown in FIG. 5, the pressure between the pressure chamber 46 and the outside space surrounding the pressure cylinder 30 can be equalized by the air inlet opening 56 which is arranged such that it is cleared by the pressure piston 32 shortly before reaching its second end position.

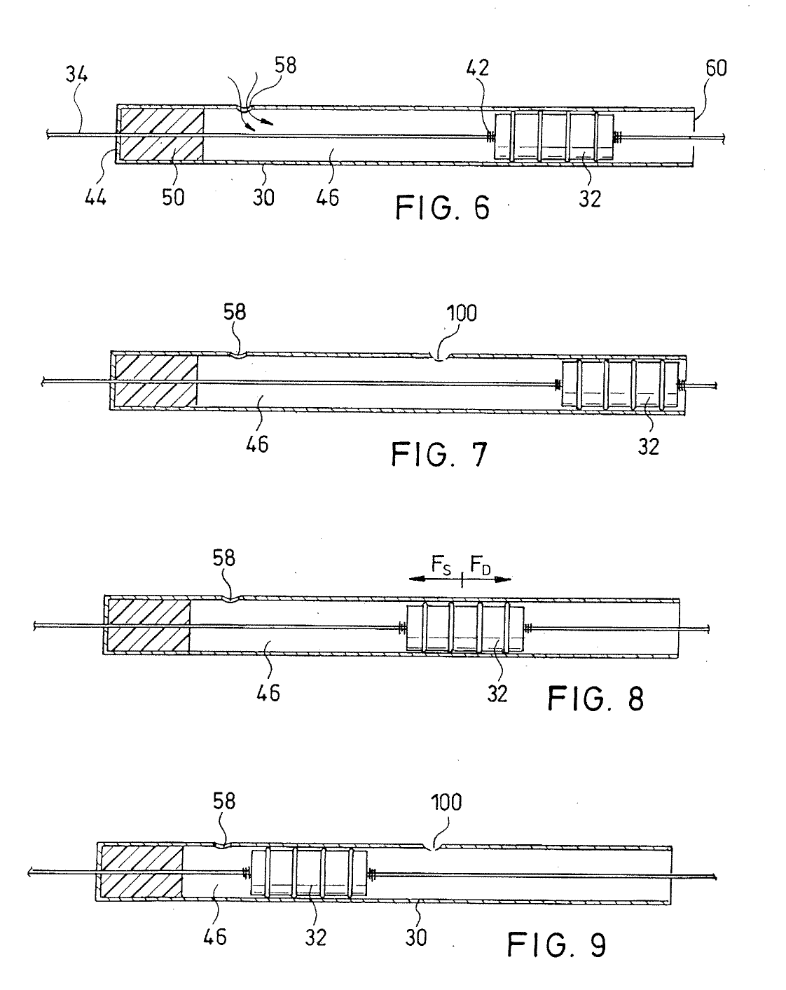

FIGS. 6 to 9 show a modified embodiment of the pressure piston 30 in which damping of the take-up motion of the length of shade material is effected by producing an overpressure in the pressure cylinder. In the version of the pressure cylinder 30 shown in FIGS. 6 to 9, it is, in turn, made as a half-open hollow section with one end 44 sealed in order to define a pressure volume 46 between the aforementioned end or a sealing element 50 located adjacent to the closed end 44 and the movable pressure piston 30. The end 60 of the pressure cylinder opposite the closed end 44 can be completely opened or can have air passage openings (not shown) which are made correspondingly large.

If the shade is closed proceeding from the opened, i.e., completely taken up position shown in FIG. 9, the pressure piston 32 moves to the right in FIG. 6, until it reaches its end position shown in FIG. 7, in which the shade is closed, i.e., is unrolled to the maximum degree from the take-up shaft. Since the pressure volume 46 is enlarged during the motion of the pressure piston 32 into the closed position, air is sucked by the negative pressure which forms here from the outside space surrounding the pressure cylinder through an air passage opening 58 located near the closed end 44 of the pressure cylinder 30 into the interior of the pressure cylinder. As soon as the shade remains long enough in the closed position, pressure equalization between the interior of the pressure cylinder 30, i.e., the pressure volume 46 and the outside space surrounding the pressure cylinder, is established via the air passage opening 58.

If the shade is opened proceeding from the completely closed position shown in FIG. 7, i.e., its free end is unlocked, the length of shade material 10 is pulled back by the force of the spring 14 of the take-up shaft 12 and the pressure piston 32 is moved to the left in FIG. 8. Since the area of the air passage opening 58 is small relative to the cross sectional area of the pressure cylinder 30, when the pressure piston 32 moves to the left in FIG. 8, an overpressure or compressive force F_{D} forms in the pressure volume 46 which counteracts the tensile force Fₛ of the cable 34, and thus, brakes the take-up motion of the length of shade. Since the force of the spring of the take-up shaft continues to act until the length of shade material 10 has been completely taken up, in this connection, air will escape from the pressure volume 46 through the air passage opening 58 until pressure equalization between the interior and exterior of the pressure cylinder 30 has been established.

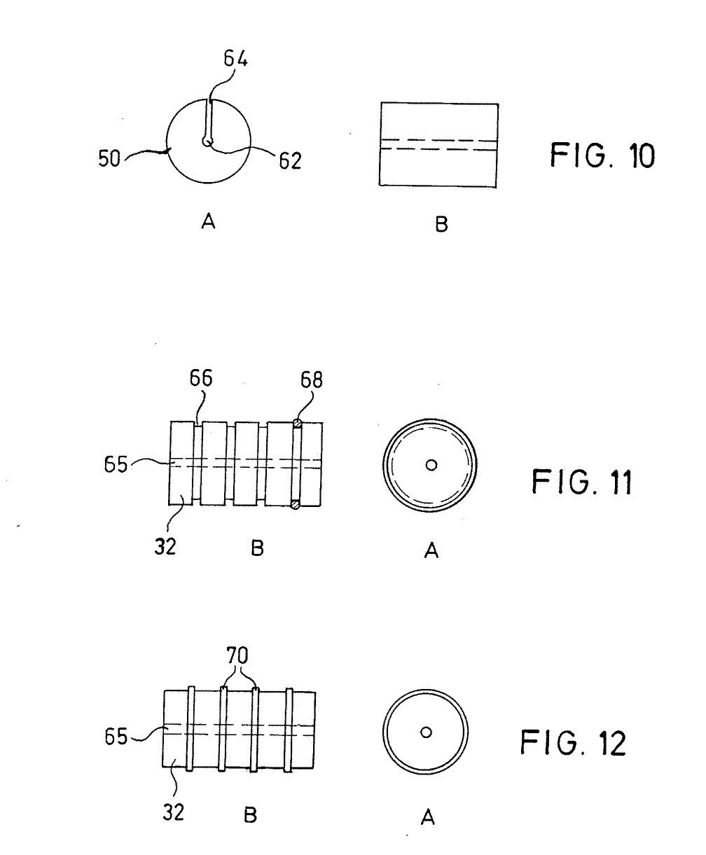

FIG. 10 shows a detailed view of a preferred embodiment of the sealing element shown in FIGS. 2 to 9. The sealing element 50, on the one hand, must provide for sealing of the pressure cylinder 30 in order to enclose the pressure volume 46 between the sealing element 50 and the pressure piston 32, and on the other hand, it must allow a displacement motion of the cable 34 to which the pressure piston 32 is attached. In order to simplify installation of the shade arrangement, the sealing element 50 preferably has an axially running slot 64 which extends to the middle 62 of the cylindrical sealing element 50 and into which the cable 34 is inserted when the shade means is installed, the center recess 62 of the sealing element 50 being dimensioned such that the it rests against the cable 34, but does not prevent its motion.

FIGS. 11 & 12 show detailed views of preferred embodiments of the pressure piston 32 shown in FIGS. 1 to 9. While the pressure piston 32 can be attached on either end to the cable 34 by the pressure piston 32 being provided with a continuous hole 65 for the cable as shown in FIGS. 11 & 12, on the ends of which the cable 32 is attached by means of cementing or welding, by crimping or by separate holding elements. Analogously to the sealing element 50 from FIG. 10, the pressure piston 32 could also be provided with a slot which extends as far as the center hole 65 and into which the cable 32 is inserted and clamped, and optionally, fixed by additional measures, such as cementing, welding, crimping, etc.

After installing the pressure piston on the cable 34, the pressure piston 34 is preferably provided with O-ring seals in order to seal it relative to the inside wall of the pressure cylinder 30. For this purpose, as is shown in FIG. 11, the pressure piston 32 can be provided with circumferentially running grooves 66, in which O-rings 68 are locked after being slipped over the pressure piston 32.

Alternatively, the pressure piston 32 and can be made in one piece with seals 70 by, as is shown in FIG. 12, the seals being molded, for example, injection molded, in one piece onto the pressure piston 32. Preferably, in this connection, the pressure piston 32 and the pressure cylinder 30 are made of the same material, for example, of plastic, since they are then subjected to the same thermal expansion, and thus, possible tightness problems caused by temperature fluctuations can be precluded from the start. If different materials are used for the pressure cylinder and the pressure piston, the embodiment shown in FIG. 11 will be provided with separate O-ring seals since here different thermal expansions of the pressure cylinder and pressure piston can be easily equalized by the corresponding elasticity of the O-rings 68.

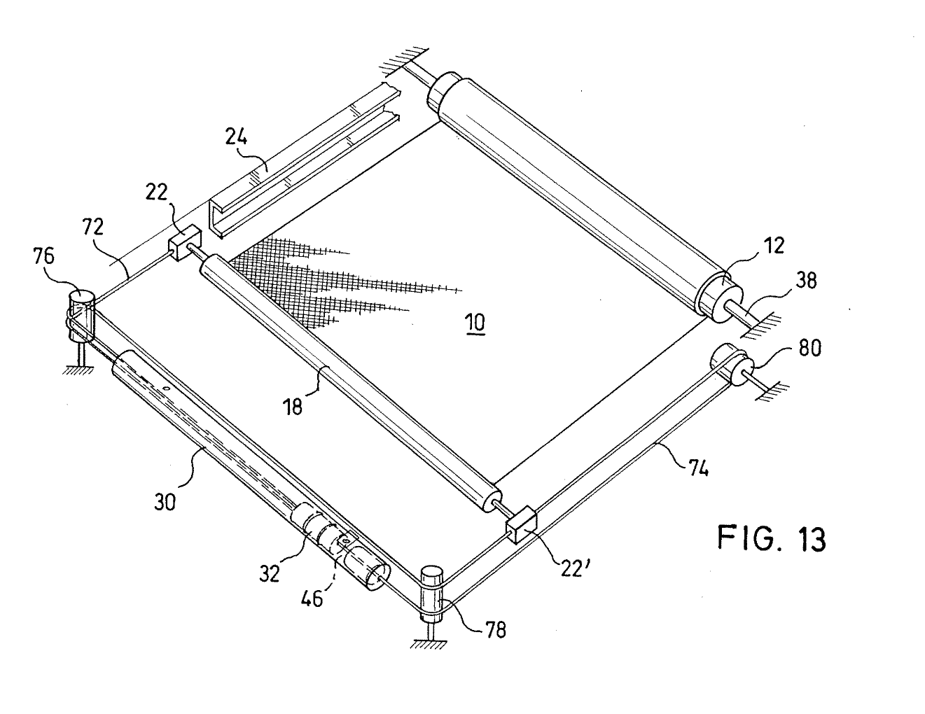

Alternatively to the embodiments in which there is a respective pressure cylinder on each side of the shade, with reference to FIGS. 13 & 14, versions of the shade means are proposed in which there is only one pressure cylinder are explained.

In particular, FIG. 13 shows an embodiment of the shade means in which a pressure cylinder 30 is located parallel to the take-up shaft 12 such that the length of shade material 10 can be stretched between the take-up shaft 12 and the pressure cylinder 30. On the free end of the length of shade material 10, in turn, a pull 18 is attached which is guided laterally by means of sliders 22 in guide rails 24, of which only one is partially shown in FIG. 13. The sliders 22 and 22′ of the pull 18 are coupled to the pressure piston 32 which is located in the pressure cylinder 30 and which can be moved via sheathed cables. In particular, the first slider 22 is connected to the pressure piston 32 via a cable 72 which is deflected via a deflection roll 76. The second slider 22 is also connected likewise to the pressure piston 32 via an circulating cable 74 which is guided in a loop via deflection rolls 76, 78 and 80.

While FIG. 13 shows one embodiment in which, when the length of shade material 10 is stretched, the pressure volume is minimized and damping of the take-up motion by a negative pressure produced in the pressure chamber 46 is achieved (as was explained in detail with reference to FIGS. 2 to 5), it goes without saying that, in this embodiment, by the corresponding alignment of the pressure cylinder 30, the version explained with reference to FIGS. 6 to 9 could be implemented with damping by overpressure.

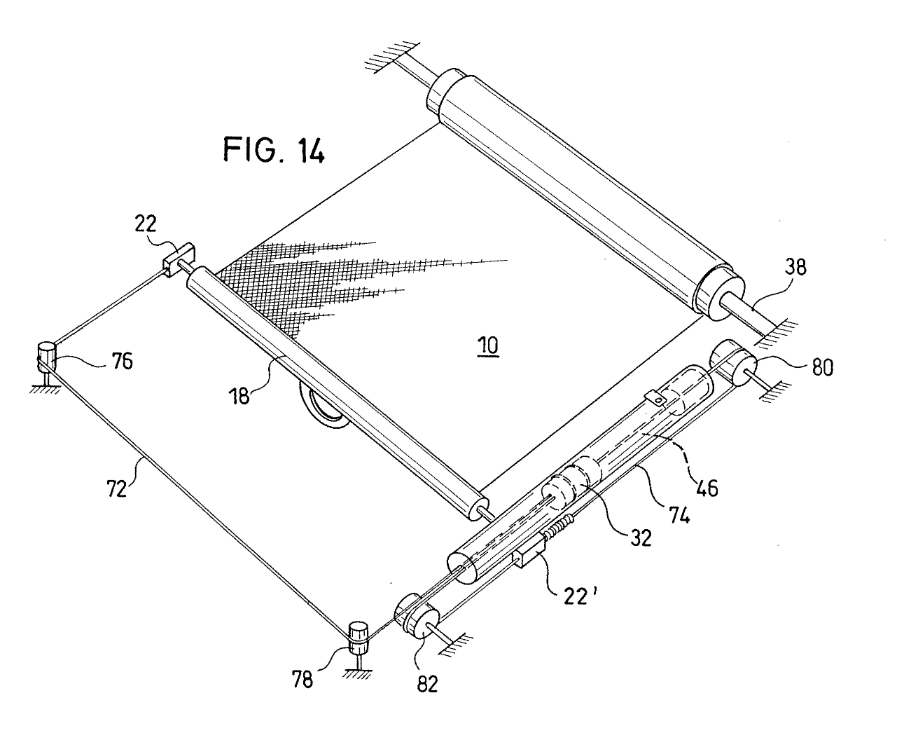

FIG. 14 shows a version of the shade means similar to that from FIG. 13; however, here the pressure cylinder 30 is not located parallel to the take-up roll, but laterally relative to the drawn length of shade. Analogously to the embodiment as shown in FIG. 13, in this connection the first slider 22 of the pull 18 is connected via a unilaterally acting cable 72 which is guided via the deflection rolls 76, 78 to the pressure piston 32 on which a circulating cable 74 additionally acts which is connected to the second slider 22′. Similar to the embodiment from FIG. 1, in the embodiments as shown in FIGS. 13 & 14, the deflection roll 80 can be located on the axle 38 of the take-up shaft 12 or can be formed by it. Moreover, in the embodiment as shown in FIG. 14, instead of the two separate deflection rolls 78, 82 there can be a common deflection roll via which both the cable 72 and also the cable 74 are deflected.

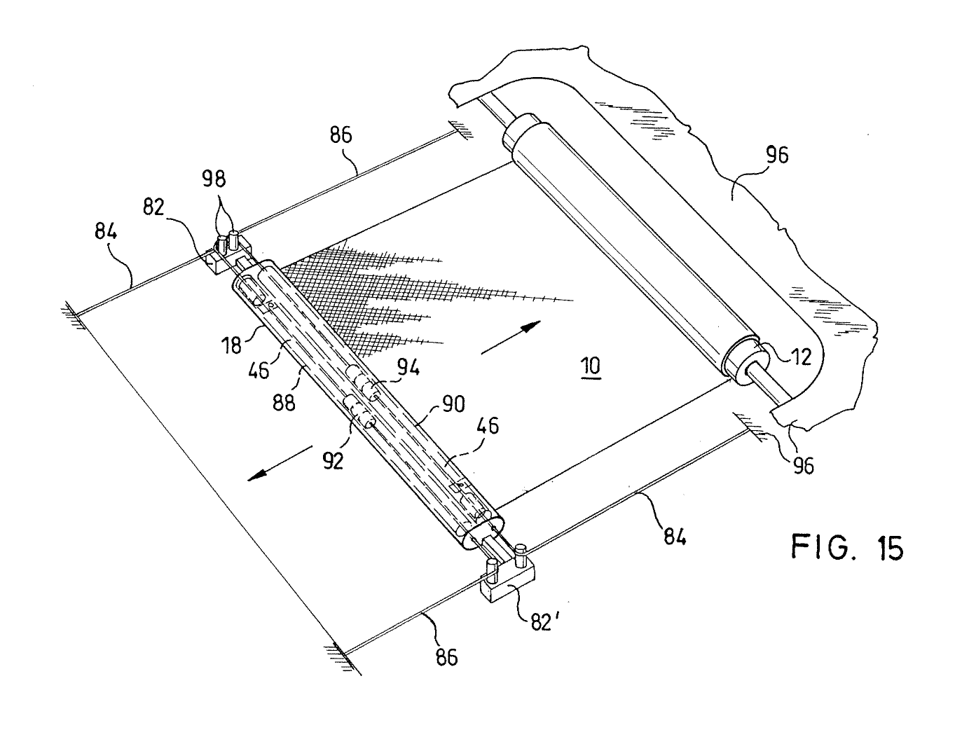

FIG. 15 shows another version of the shade means in which two pressure cylinders are integrated into the pull 18 of the shade means. In this connection, the pull 18 is in turn guided via lateral sliders 82 in guide rails (not shown) which are located along the length of shade.

In the pull 18, are a first pressure cylinder 88 and a second pressure cylinder 90 with pressure pistons 92, 94 which are coupled via cables 86, 84 to the sliders 82, 82′ of the pull 18. Different from in the above described embodiments, in which the cable length between the pressure pistons and the sliders is the same in all positions of motion of the shade means, in the version as shown in FIG. 15, the cables 84, 86 are not fixed with respect to the sliders 82, 82′, but are attached to a frame 96 which surrounds the shade means and which, for example, can be formed by the fixed surface of a vehicle roof or of a roof frame located underneath, such a roof surface. As is shown in FIG. 15, the cables 84, 86 are guided around the deflections rolls 98 attached to the sliders 82 such that they cross on one of the sliders (in FIG. 15, at slider 82).

In the version of FIG. 15, the pressure cylinders 88, 90 are designed as pressure cylinders which work with negative pressure damping, as was explained with reference to FIGS. 2 to 5. However, it goes without saying that the pressure cylinders 88, 90 can also be designed as pressure cylinders which work with overpressure, as was explained with reference to FIGS. 6 to 9. Furthermore, one of the two pressure cylinders 88 or 90 can be omitted, still preferably, two sheathed cables being used according to the sheathed cables 84, 86 in order to avoid skewing of the pull 18.

With repeated reference to FIGS. 2 to 9, it goes without saying that the shade means proposed here can be diversely modified. In particular, in an especially simplified version of the embodiment shown in FIGS. 2 to 5, the openings 54, 56 can be entirely omitted, and then, provision should be made for preferably normal pressure or a slight negative pressure instead of an overpressure prevailing in the pressure volume 46 in the position of the length of shade material in which the pressure volume 46 is minimum, which position is shown completely opened in FIG. 3, i.e., the taken-up position. Then, if the shade, in this position, is released so that the pressure piston 32 moves to the left in FIG. 3, in the pressure volume 46, a negative pressure, and thus, a braking force F_{D} arise which counteracts the cable force F_{S} caused by the spring of the take-up shaft, and thus, brakes the take-up motion of the length of shade. While in such a simplified version a corresponding damping behavior would be achieved, here however, the pressure volume 46 is not relieved when the shade reaches its taken-up end position.

FIGS. 7 & 9 show another version of the shade means in which the damping behavior of the pressure cylinder 30 has been modified by making providing another air passage opening 100. In embodiments with several air passage openings, as is explained below relative to the example with two air passage openings 58, 100, in the first part of the take-up motion proceeding from the completely closed position of the shade in FIG. 7, greater air escape through the air passage openings 58, 100 takes place, and thus, lower damping than in the second part of the take-up motion in which the pressure piston 32 has passed the air passage opening 100, and therefore, air can escape from the pressure volume 46 only through the air passage opening 58. It goes without saying that the damping behavior of the pressure piston 30 can be further modified by providing additional air passage openings.

When the pressure cylinder or cylinders 30 is or are located laterally parallel to the drawing direction of the length of shade material 10, as is illustrated in FIGS. 1 & 14, the pressure cylinders 30 can be integrated together with the guide rails 24 for the sliders 22 in a profile component, as is illustrated in FIG. 16. In particular, FIG. 16 shows a section through the roof frame as can be used especially in a motor vehicle in which a shade means is used in order to limit light incidence through a transparent or translucent cover. The guide rail 24 can have guide channels 102, 106 in this case, in which sliders of the shade means and sliders of a movable cover for closing the roof opening are supported. The guide rail 24 also has a hollow profile section 106 in which a pressure piston 32 is located, and which is thus used as a pressure cylinder 30.

Furthermore, the guide rail 24 can have fastening and/or stabilizing elements and can be integrated in one piece in the roof frame which surrounds the roof opening.

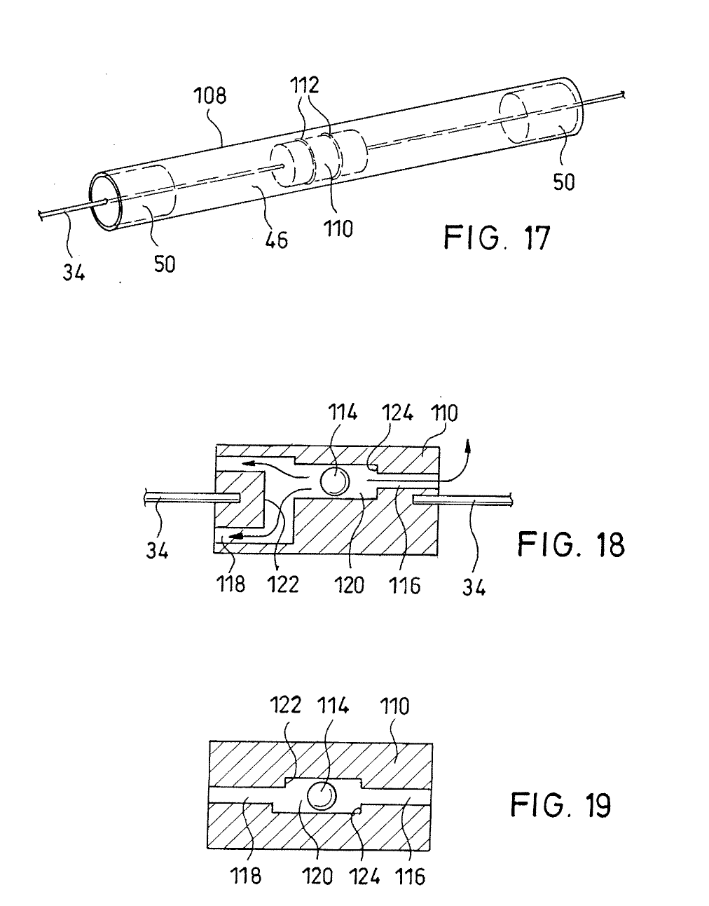

FIGS. 17 to 19 schematically show another version of a pressure cylinder. Different from the pressure cylinders which are shown in FIGS. 2 to 9 and which are closed on only one side by a sealing element 50 to form the pressure volume 46, in the pressure cylinder 108 shown in FIG. 17, there is a sealing element 50 at each end of cylinder 108, the cable 34 being able to move through the sealing elements 50, but escape of air through the sealing elements 50 being largely prevented. In the pressure cylinder 108, a pressure piston 110 is movably located, and in turn, it is sealed by O-rings 112 relative to the inside wall of the pressure cylinder 108 and the cable 34 is attached to it on both sides.

As is indicated in FIGS. 18 & 19, the pressure piston 110 contains a valve the functions to pass air more quickly in one direction, but more slowly in the other direction in order to cause a braking action. For this purpose, there can be a valve ball 114 in the pressure piston 110 which works in the manner of a return or flash valve which prevents air from flowing through in one direction, but allows flow in the other direction. For example, the pressure piston 110 can have a first air channel 116 and as shown in FIG. 19, or as shown in FIG. 18, several second air channels 118 which each discharge into a chamber 120 in which the valve ball 114 is located to be able to move freely. The geometry of the chamber 120 and of the air channels 116, 118 is chosen here such that, when in the motion of the pressure piston 110 in one direction (to the right in FIG. 17) air flows in through the first air channel 116, the valve ball 114 rests against a first stop surface 122, and in doing so, enables the passage of air through the air channel or channels 118. Conversely, if the pressure piston 110 moves in the other direction, the valve ball 114 is displaced by the air flowing in through the air channel or second air channel or channels 118 such that it rests against a second stop surface 124, and in doing so, blocks air passage through the first air channel 116.

The design shown in FIGS. 17 to 19 has the advantage that penetration of dirt particles or lubricants into the pressure cylinder is prevented by the bilateral encapsulation of the pressure cylinder 34.

1-23. (canceled)

24. Shade arrangement, comprising:
a length of shade material,
a take-up roll to which the length of shade material is attached and which is pretensioned by spring force in a take-up direction of the length of shade material,
a pressure volume coupled to a free end of the length of shade material such that, when the length of shade material is unrolled from the take-up roll, a pressure is built up in the pressure volume which, when the length of shade material is released from a position which is at least partially unrolled from the take-up roll, a take-up motion of the length of shade material is braked thereby.

25. Shade arrangement as claimed in claim 24, wherein the pressure volume is coupled to the free end of the length of shade material via a sheathed cable arrangement.

26. Shade arrangement as claimed in claim 24, further comprising a pull on the free end of the length of shade material.

27. Shade arrangement as claimed in claim 26, further comprising lateral guide rails on which the pull is guided to move via sliders which are connected to the pull.

28. Shade arrangement as claimed in claim 24, wherein the pressure volume is formed by a pressure cylinder which is coupled to the free end of the length of shade material.

29. Shade arrangement as claimed in claim 28, wherein a movable pressure piston which varies the size of the pressure volume is positioned in the pressure cylinder.

30. Shade arrangement as claimed in claim 29, wherein the pressure piston is coupled to the free end of the length of shade material via a sheathed cable arrangement.

31. Shade arrangement as claimed in claim 29, wherein the pressure piston is shifted during the take-up motion of the length of shade material between a first end position in which the pressure volume is minimum, and a second end position in which the pressure volume is maximum.

32. Shade arrangement as claimed in claim 31, wherein the pressure built up in the pressure volume is a negative pressure, wherein the pressure piston is in the first end position when the length of shade material is unrolled from the take-up roll to a maximum degree, and wherein the pressure piston produces said negative pressure in the pressure volume when moved from the first end position toward the second end position.

33. Shade arrangement as claimed in claim 32, wherein the pressure cylinder has an air inlet opening and an air outlet opening which has a one-way valve, said openings being arranged such that the pressure volume is vented via the air outlet opening during movement of the pressure piston in the direction toward the first end position, said negative pressure being produced in the pressure volume during displacement of the pressure piston in the direction toward the second end position, and air being able flow into the pressure volume through the air inlet opening when the pressure piston reaches the second end position.

34. Shade arrangement as claimed in claim 31, wherein the pressure built up in the pressure volume is an overpressure, wherein the pressure piston is in the second end position when the length of shade material is unrolled from the take-up roll to the maximum degree, and wherein the pressure piston produces said overpressure in the pressure volume when moved in the direction toward the first end position.

35. Shade arrangement as claimed in claim 34, wherein the pressure cylinder has an air passage opening which is arranged such that air can flow into the pressure volume through the air passage opening when the pressure piston moves in the direction toward the second end position and air can escape from the pressure volume when the pressure piston moves in the direction toward the first end position.

36. Shade arrangement as claimed in claim 30, wherein the sheathed cable arrangement comprises a cable which penetrates the pressure piston.

37. Shade arrangement as claimed in claim 36, wherein the pressure piston has an axial slot in to which the cable is inserted.

38. Shade arrangement as claimed in claim 30, wherein the sheathed cable arrangement comprises a cable which is attached to opposite sides of the pressure piston.

39. Shade arrangement as claimed in claim 30, wherein the pressure piston is attached to the cable by means of at least one of clamping, cementing, welding, crimping and separate holding elements.

40. Shade arrangement as claimed in claim 30, wherein the sheathed cable arrangement has a circulated cable which is coupled to the free end of the length of shade material and to the pressure piston.

41. Shade arrangement as claimed in claim 30, wherein a compensation element is connected to the cable.

42. Shade arrangement as claimed in claim 30, further comprising lateral guide rails on which a pull on the free end of the length of shade material is guided to move via sliders which are connected to the pull; wherein, on each lateral side of the length of shade material, a respective pressure cylinder is coupled to a respective one of the sliders.

43. Shade arrangement as claimed in claim 30, further comprising lateral guide rails on which a pull on the free end of the length of shade material is guided to move via sliders which are connected to the pull; wherein the pressure cylinder is connected to the sliders via the sheathed cables.

44. Shade arrangement as claimed in claim 30, further comprising lateral guide rails on which a pull on the free end of the length of shade material is guided to move via sliders which are connected to the pull; wherein the pressure cylinder is located in the pull.

45. Motor vehicle roof, comprising:
a fixed roof surface with an opening and a transparent or translucent cover panel closing the opening, and
a shade arrangement for selectively covering and uncovering the cover panel, said shade arrangement comprising:
a length of shade material,
a take-up roll to which the length of shade material is attached and which is pretensioned by spring force in a take-up direction of the length of shade material,
a pressure volume coupled to a free end of the length of shade material such that, when the length of shade material is unrolled from the take-up roll, a pressure is built up in the pressure volume which, when the length of shade material is released from a position which is at least partially unrolled from the take-up roll, a take-up motion of the length of shade material is braked thereby.

46. Motor vehicle roof as claimed in claim 45, further comprising lateral guide rails on which a pull on the free end of the length of shade material is guided to move via sliders which are connected to the pull; wherein the pressure volume is formed by a pressure cylinder which is coupled to the free end of the length of shade material, and wherein the pressure cylinder is formed by a hollow profile provided in the guide rails.
